(19) United States
(12) Patent Application Publication
(10) Pub. No.: US 2014/0152669 A1
(43) Pub. Date: Jun. 5, 2014

(54) Apparatus, Method and Program for Information Processing

(71) Applicant: P&W Solutions Co., Ltd., Tokyo (JP)

(72) Inventor: Toshiyuki Omiya, Tokyo (JP)

(21) Appl. No.: 13/898,721

(22) Filed: May 21, 2013

(30) Foreign Application Priority Data
May 28, 2012 (JP) 2012-120586

(51) Int. Cl. G06T 11/20

(52) U.S. Cl. CPC G06T 11/206
USPC 345/440.1

(57) ABSTRACT

The invention provides an information processing apparatus, which can adjust a display range of a time series graph using one operating portion. An information processing apparatus 100 includes: a reference setting unit 11 which sets an initial range of a time series graph 81 and 83; a display control unit 15 which displays the graphs 81 and 83 by associating their time axes with each other; and a range adjustment unit 14 which adjusts the range of the graph 81 by moving, when the starting position of the operation is either of the range specifying portions 82L and 82R, the portion 82L or 82R along the time axis and by moving, when the starting position is in between the portions 82L and 82R, each of the portions 82L and 82R along the time axis with the distance between the portions 82L and 82R maintained.

This application is based on and claims the benefit of priority from Japanese Patent Application No. 2012-120586, filed on 28 May 2012, the content of which is incorporated herein by reference.

### BACKGROUND OF THE INVENTION

1. Field of the Invention

The present invention relates to an apparatus, a method and a program for information processing which adjust a display range of a time series graph.

2. Related Art

In recent years, a management method known as WFM (Workforce Management) which adjusts balance between maintenance of the quality of service and labor cost has gained attention. For example, in a contact center (call center) which serves as a technical support desk for customers, the number of people needed is predicted in advance from analysis of the operating status of each operator in order to maintain the quality of reply to customers while preventing increase of the labor cost, thus achieving efficient workforce use and deployment.

“Sweet Series” provided by P&W Solutions Co., Ltd. is widely known as a suitable tool for WFM. This tool enables prediction of traffic intensity distribution using time series graphs which display information such as past traffic intensity and reply result in time series.

Meanwhile, the user who uses a time series graph sometimes desires to adjust the time series graph, that is, the user sometimes desires to perform expansion/contraction of the time series graph or change a display position of the time series graph (hereafter referred to as “scroll”). For example, changing a time series graph for one week into a time series graph for one day corresponds to expansion of the time series graph, and changing a time series graph for one day into a time series graph for one week corresponds to contraction of a time series graph. In addition, for example, changing a time series graph that displays 15:00 in the middle into a time series graph that displays 10:00 in the middle corresponds to a scroll of the time series graph.

Therefore, it is common to enable expansion/contraction and scroll of a time series graph in a conventional tool that provides a time series graph. However, in a conventional tool, expansion/contraction and scroll are accepted using different operating portions, and further improvement in convenience is desired.

Patent Document 1 describes an information processing apparatus that searches for information for a period specified by a button that moves along a time axis. This information processing apparatus enables selection of a range and a position in a period for searching with one operating portion (user interface) by making the width and the position of the button changeable (FIG. 4).

Patent Document 1: Japanese Unexamined Patent Application, Publication No. 2005-157756

### SUMMARY OF THE INVENTION

However, the information processing apparatus in Patent Document 1 does not enable expansion/contraction or scroll of the time series graph but rather enables selection of the period for searching. In addition, in the information processing apparatus in Patent Document 1, it is not possible to know what kind of information is included in the search period, which is selected by a button, unless the search result is displayed, and thus the user needs to try many times to operate the button for finding desired information.

The present invention has been achieved in view of such problems and an object of the invention is to provide an apparatus, a method and a program for information processing, which can attain adjustment of a display range of a time series graph with one operating portion. Preferably, the present invention aims to provide an apparatus, a method and a program for information processing that can have knowledge of a post-adjustment time series graph during the adjustment of the time series graph that uses one operating portion.

A first aspect of the present invention is an information processing apparatus, including:

a reference setting unit which sets an initial range of a time series graph; a display control unit which displays on a display unit the time series graph having the set initial range and an operating portion having a time axis that corresponds to a time axis of the time series graph by associating the time axes with each other; an operation accepting unit which accepts an operation of a user using a range specifying portion which is arranged at both ends of the operating portion in the time axis direction and moves along the time axis; and a range adjustment unit which adjusts a range of the time series graph by moving, when a starting position of an operation that the operation accepting unit accepted is either of the range specifying portions, the operated range specifying portion along a time axis of the operating portion, and by moving, when the starting position is in between the range specifying portions, both of the range specifying portions along the time axis of the operating portion with a distance between the range specifying portions being maintained; in which the display control unit displays on the display unit the time series graph having a range adjusted by the range adjustment unit.

According to such a configuration, the information processing apparatus can adjust a time series graph with only one operating portion, which is a range specifying portion which moves along the time axis of the operating portion. At this time, since the operating portion has a time axis corresponding to the time axis of the time series graph to be adjusted, it is possible to have knowledge of the post-adjustment time series graph during the adjustment and to improve the convenience.

A second aspect of the present invention is the information processing apparatus according to the first aspect, in which the operating portion is a time series graph which is a substantially contracted graph of the time series graph.

According to such configuration, it is possible to have knowledge of the characteristics of the time series graph to be adjusted from the substantially contracted time series graph, which is displayed as an operating portion, and thus easily adjust to a position the user desires.

A third aspect of the present invention is the information processing apparatus according to the first aspect, in which on a condition that the operation accepting unit accepts a selection operation performed onto an arbitrary position in the time axis direction of the operating portion, the range adjustment unit adjusts the range of the time series graph to a range in which the arbitrary position is in a middle of the range.

According to such a configuration, by the user only selecting an arbitrary position in the time axis direction, the information processing apparatus can display the time series graph that has the arbitrary position in the middle and improve convenience.

A fourth aspect of the present invention is the information processing apparatus according to the first aspect, further including a second operation accepting unit which accepts an operation from the user using a second range specifying portion which is provided along an axis perpendicular to the time axis of the time series graph and moves along an axis corresponding to the axis, in which the display control unit displays on the display unit a time series graph having a range determined by the second range specifying portion.

According to such a configuration, the information processing apparatus can adjust the time series graph along an axis perpendicular to the time axis.

A fifth aspect of the present invention is a method for a computer to adjust a display range of a time series graph, including: a step of setting an initial range of the time series graph; a step of displaying on a display unit the time series graph having the set initial range and an operating portion having a time axis that corresponds to a time axis of the time series graph by associating the time axes with each other; a step of accepting an operation of a user using a range specifying portion which is arranged at both ends of the operating portion in the time axis direction and moves along the time axis; a step of adjusting a range of the time series graph by moving, when a starting position of an accepted operation is on either of the range specifying portions, the operated range specifying portion along a time axis of the operating portion, and by moving, when the starting position is in between the range specifying portions, both of the range specifying portions along the time axis of the operating portion with a distance between the range specifying portions being maintained; and a step of displaying on the display unit the time series graph having an adjusted range.

A sixth aspect of the present invention is a program for causing a computer to adjust a display range of a time series graph, the program causing the computer to execute: a step of setting an initial range of the time series graph; a step of displaying on a display unit the time series graph having the set initial range and an operating portion having a time axis that corresponds to a time axis of the time series graph by associating the time axes with each other; a step of accepting an operation of a user using a range specifying portion which is arranged at both ends of the operating portion in the time axis direction and moves along the time axis; a step of adjusting a range of the time series graph by moving, when a starting position of an accepted operation is on either of the range specifying portions, the operated range specifying portion along a time axis of the operating portion, and by moving, when the starting position is in between the range specifying portions, both of the range specifying portions along the time axis of the operating portion with a distance between the range specifying portions being maintained; and a step of displaying on the display unit the time series graph having an adjusted range.

According to such a configuration, the same effect as the first aspect can be expected.

According to the present invention, the user can adjust a display range of a time series graph using one operating portion while having knowledge of the post-adjustment time series graph.

### BRIEF DESCRIPTION OF THE DRAWINGS

FIG. 1 is a block view showing a hardware configuration of the information processing apparatus;

FIG. 2 is a block view showing a functional configuration of the information processing apparatus;

FIG. 3 is a diagram showing a time series graph displayed on the display unit;

FIGS. 4A and 4B are diagrams showing a situation of the adjustment of the display range based on the operation of the user;

FIGS. 5A and 5B are diagrams showing a situation of the adjustment of the display range based on the operation of the user;

FIGS. 6A and 6B are diagrams showing a situation of the adjustment of the time series graph based on the operation of the user;

FIG. 7 is a flow chart showing the flow of processing of the information processing apparatus; and

FIGS. 8A and 8B are diagrams showing the display mode of a display unit in another embodiment.

### DETAILED DESCRIPTION OF THE INVENTION

Hereafter, embodiments of the present invention will be described with reference to the drawings.

### [Hardware Configuration of the Information Processing Apparatus 100]

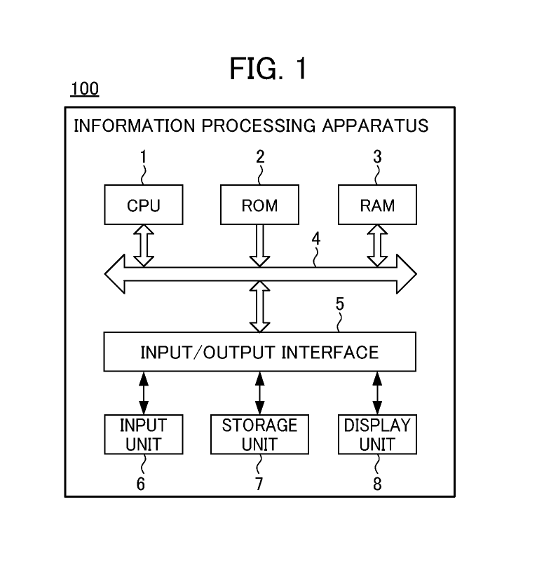

First, a hardware configuration of the information processing apparatus 100 of the present invention will be described with reference to FIG. 1.

The information processing apparatus 100 is a terminal unit of, for example, a personal computer, a tablet computer or a mobile phone, and includes: a CPU (Central Processing Unit) 1, a ROM (Read Only Memory) 2, RAM (Random Access Memory) 3, a bus 4, an input/output interface 5, an input unit 6, a storage unit 7 and a display unit 8.

The CPU 1 executes various kinds of processes according to programs recorded in the ROM 2 or programs loaded onto the RAM 3 from the storage unit 7. In addition, the RAM 3 stores, for example, data, that is required for executing various kinds of processes by the CPU 1 as appropriate.

The CPU 1, the ROM 2 and the RAM 3 are connected with each other via the bus 4. Also connected to the bus 4 is the input/output interface 5 to which the input unit 6, the storage unit 7, the display unit 8 or the like are connected.

The input unit 6 is constituted by various buttons or the like, and accepts an operation of the user to supply the input information according to the operation to the CPU 1 or the like. It should be noted that examples of such various buttons include not only a hardware button but also a software button (so-called a touch panel) displayed on the screen of the display unit 8. In this respect, the input unit 6 is constituted by a touch panel provided in the display unit 8 in the present embodiment.

The storage unit 7 may be constituted by any storage device, such as an HDD (Hard disk drive) and an SSD (Solid state drive), and stores various programs executed by the CPU 1. In addition, the storage unit 7 stores, for example, various kinds of data for generating a time series graph as described below.

The display unit 8 is constituted by a display or the like and displays a variety of information, such as images and numerical information.

In the information processing apparatus 100 configured as such, the CPU 1 controls the display in the display unit 8 according to the operation of the user accepted via the input unit 6. Specifically, the CPU 1 performs expansion/contraction and scroll of the time series graph displayed on the display unit 8 according to the operation of the user. At this time, the input unit 6 accepts the operation of the user for both the expansion/contraction and scroll of the time series graph at one operating portion.

Hereafter, a functional configuration for performing expansion/contraction and scroll of the time series graph, that is, adjustment of the time series graph, will be described.

### [Functional Configuration of the Information Processing Apparatus 100]

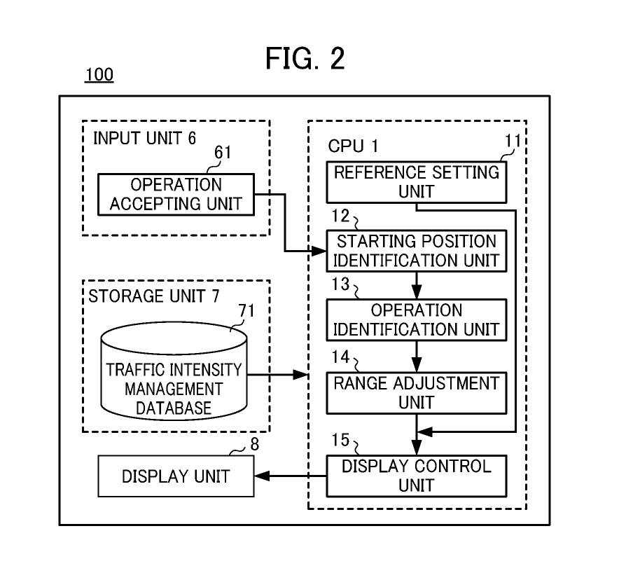

FIG. 2 is a block view showing a functional configuration of the information processing apparatus 100 of the present invention. As shown in FIG. 2, when adjusting the time series graph, the input unit 6 of the information processing apparatus 100 functions as an operation accepting unit 61, and the CPU 1 functions as the reference setting unit 11, the starting position identification unit 12, the operation identification unit 13, the range adjustment unit 14 and the display control unit 15. In addition, the storage unit 7 is provided with a traffic intensity management database 71.

The traffic intensity management database 71 stores information for generating a time series graph, that is, data plotted onto the time series graph. The CPU 1 reads information stored in the traffic intensity management database 71 and generates a time series graph for a predetermined period. Then, the CPU 1 displays the generated time series graph onto the display unit 8.

The operation accepting unit 61 accepts the operation of the user performed against the information processing apparatus 100. In the present embodiment, since the input unit 6 is constituted with a touch panel, the operation accepting unit 61 accepts a touch operation performed onto information displayed on the display unit 8. Of course, the input unit 6 can also be constituted with units other than a touch panel. In this case, the input unit 6 accepts an operation according to the type of the input unit 6. For example, the input unit 6 accepts a click operation performed onto information displayed on the display unit 8, or an input operation using a keyboard.

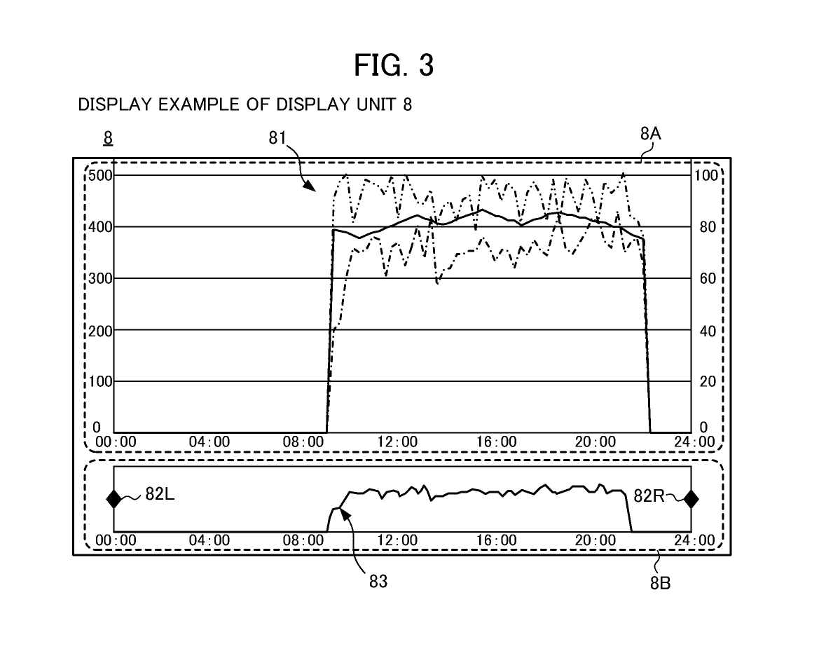

Here, information displayed on the display unit 8 will be described with reference to FIG. 3. The display unit 8 includes a main display portion 8A and an auxiliary display portion 8B.

The main display portion 8A is a region for displaying detailed information that is checked by the user. In the present, the main display portion 8A displays a time series graph 81. In FIG. 3, the main display portion 8A displays the time series graph 81 showing information about traffic intensity in the contact center (e.g., response rate, actually resulted traffic intensity, and predicted traffic intensity). It should be noted that the time series graph 81 to be displayed in the main display portion 8A is not limited to traffic intensity in a contact center but may adopt any time series graph, such as a stock price chart.

The auxiliary display portion 8B is a region for accepting an operation for adjusting the display content in the main display portion 8A, that is, a region for accepting an operation for adjusting the time series graph 81 displayed in the main display portion 8A, and is provided along the time axis of the time series graph 81. In addition, the auxiliary display portion 8B displays a time series graph 83 which has a time axis having the same length of appearance as the time series graph 81. That is, both ends of the time series graph 83 displayed in the auxiliary display portion 8B match with both ends of the time series graph 81 displayed in the main display portion 8A in a direction perpendicular to the time axis.

The time series graph 83 is a time series graph which is made by contracting the time series graph 81 based on characteristics of the time series graph 81 displayed in the main display portion 8A. For example, since the time series graph 81 shown in FIG. 3 has characteristics of rising at past 08:00 and finishing at past 21:00, the time series graph 83 has the same characteristics also. It should be noted that, the time series graph 83 is sufficient as long as it is possible to have knowledge of the characteristics of the time series graph 81, and one time series graph 83 may be provided for a plurality of time series graphs 81 as shown in FIG. 3. In addition, although not illustrated, a plurality of time series graphs 83 may be provided for a plurality of time series graphs 81. Such contraction based on the characteristics of the time series graph 81 is called “substantially contracted”.

In addition, range specifying portions 82L and 82R for adjusting the range of the time series graph 81 displayed in the main display portion 8A are provided on both ends of the time series graph 83 in the time axis direction. Although the details will be described later, the time series graph 81 is displayed in the main display portion 8A from the time specified by the range specifying portion 82L to the time specified by the range specifying portion 82R. The range specifying portions 82L and 82R move along the time axis of the time series graph 83 by being operated by the user.

Returning to FIG. 1, the operation accepting unit 61 accepts the operation for moving the range specifying portion 82L or 82R of the auxiliary display portion 8B on the time series graph 83. Although the details will be described later, the operation accepting unit 61 accepts a tap operation and a drag operation performed onto a position in the auxiliary display portion 8B. It should be noted that a tap operation means to select a position and then cancel the selection without moving the selected position; and a drag operation means to select a position and then cancel the selection after moving the selected position. The operation accepting unit 61 supplies the accepted operation to the CPU 1.

Next, the reference setting unit 11 sets an initial range of the time series graphs 81 and 83 which are to be displayed in the main display portion 8A and the auxiliary display portion 8B, respectively. For example, the reference setting unit 11 sets an arbitrary period, such as half a day, one day, and one week, as an initial range. In addition, the reference setting unit 11 supplies the set initial range to the display control unit 15.

The display control unit 15 generates the time series graphs 81 and 83 by reading from the traffic intensity management database 71 data corresponding to the initial range supplied from the reference setting unit 11 and then displays the graphs onto the display unit 8. In FIG. 3, the time series graphs 81 and 83 in which a period for one day is set as an initial range are displayed on the display unit 8.

The starting position identification unit 12 identifies a starting position of the operation accepted by the operation accepting unit 61, that is, a starting position of a selected position selected by the user. In addition, the starting position identification unit 12 supplies the identified starting position to the range adjustment unit 14.

The operation identification unit 13 identifies the type of operation accepted by the operation accepting unit 61. It should be noted that the type of operation for identification includes at least a tap operation and a drag operation. In addition, the operation identification unit 13 supplies the identified type of operation to the range adjustment unit 14.

The range adjustment unit 14 adjusts the range of the time series graph 81 displayed in the main display portion 8A based on the starting position of operation and the type of operation accepted by the operation accepting unit 61. Specifically, the range adjustment unit 14 adjusts the range of the time series graph 81 such that the range becomes a range specified by the range specifying portions 82L and 82R that have been moved along the time axis of the time series graph 83 according to the operation that the operation accepting unit 61 has accepted.

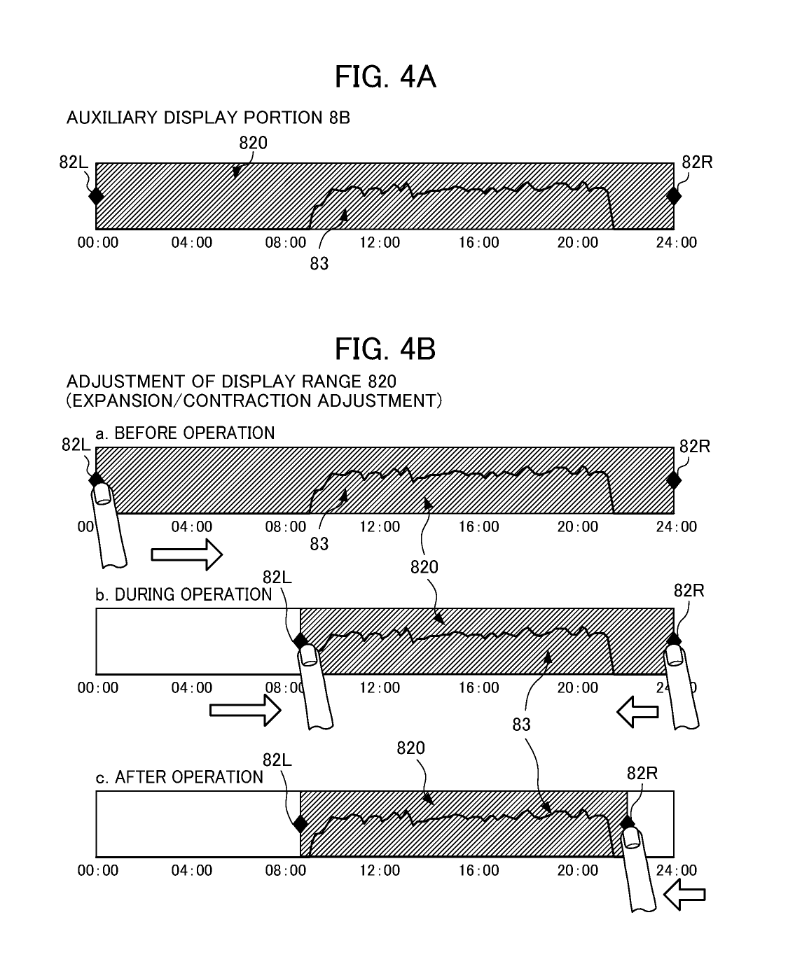

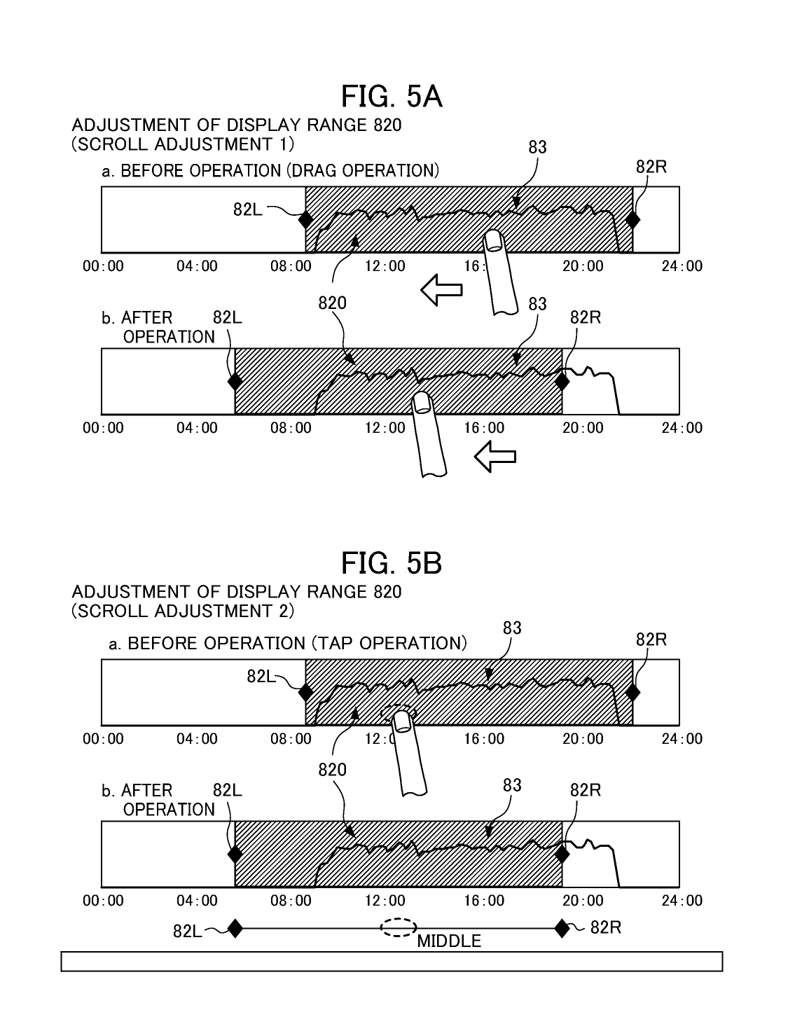

Here, adjustment of the range of the time series graph 81 based on the range specifying portions 82L and 82R will be described with reference to FIGS. 4A,4B and FIGS. 5A,5B. It should be noted that, in FIGS. 4A,4B and FIGS. 5A,5B, only the range specifying portions 82L and 82R of the auxiliary display portion 8B are shown and illustration of the time series graph 81 of the main display portion 8A is omitted.

Referring now to FIG. 4A, the range of the time series graph 81 displayed in the main display portion 8A is specified by the range specifying portions 82L and 82R which move along the time axis. Hereafter, the range specified by the range specifying portions 82L and 82R is called a display range 820. In FIG. 4A, the display range 820 specifies the range of 00:00 to 24:00, and therefore the time series graph 81 of 00:00 to 24:00 is displayed in the main display portion 8A. Here, in a state where the initial range is set (initial state), the range specifying portions 82L and 82R are located at both ends of the time series graph 83 in the time axis direction. Therefore, in the initial state, the display range 820 shows the entire time series graph 83 and thus the time series graph 81 and the time series graph 83 have the same range. Meanwhile, when the operation accepting unit 61 accepts the operation of the user, the range specifying portions 82L and 82R move along the time axis and therefore the display range 820 changes. As a result, the time series graph 81 and the time series graph 83 have different ranges.

Next, referring now to FIG. 4B, adjustment of the display range 820 based on the operation of the user, especially, expansion/contraction adjustment of the display range 820, will be described. It should be noted that, if the display range 820 becomes narrow, the time series graph 81 expands, and if the display range 820 becomes broad, the time series graph 81 contracts.

If the user selects and drags a range specifying portion 82L or 82R along the time axis, only the selected range specifying portion 82L or 82R moves along the time axis. A range specifying portion 82L is selected and dragged in FIG. 4B-a. Therefore, only the selected range specifying portion 82L moves while the range specifying portion 82R that is not selected is fixed (FIG. 4B-b). Thereafter, if the range specifying portion 82R is selected and dragged, the selected range specifying portion 82R moves while the range specifying portion 82L that is not selected is fixed (FIG. 4B-c).

Hence, if the starting position of operation is either of the range specifying portions 82L and 82R, and the type of operation is a drag operation, the range adjustment unit 14 moves the operated range specifying portion 82L or 82R along the time axis and adjusts the range of the display range 820. In FIG. 4B, the display range 820 which has shown a range of 00:00 to 24:00 (FIG. 4B-a) is adjusted to show a range of about 08:00 to about 21:00 in accordance with the operation of the user (FIG. 4B-c).

Next, referring now to FIGS. 5A,5B, scroll adjustment of the display range 820 based on the operation of the user will be described.

Referring now to FIG. 5A, when the user selects a portion between the range specifying portions 82L and 82R and drags the portion along the time axis, the range specifying portions 82L and 82R respectively move along the time axis with the distance between the range specifying portions 82L and 82R maintained. In FIG. 5A, a portion near 16:00 in the time axis direction is selected (FIG. 5A-a) and then the portion is dragged to a portion near 13:00 (FIG. 5A-b). Therefore, the display range 820 scrolls a length corresponding to about 3 hours with the distance between the range specifying portions 82L and 82R maintained.

Hence, when the starting position of operation is in between the range specifying portions 82L and 82R and the type of operation is a drag operation, the range adjustment unit 14 moves each of the range specifying portions 82L and 82R along the time axis with the distance between the range specifying portions 82L and 82R maintained and adjusts the range of the display range 820. In FIG. 5A, the display range 820, which has been showing the range of about 08:00 to about 21:00 (FIG. 5A-a), is adjusted to show the range of about 05:00 to about 19:00 according to the operation of the user (FIG. 5A-b).

Referring now to FIG. 5B, when the user performs a tap operation at an arbitrary position in the time axis direction anywhere in the time series graph 83, each of the range specifying portions 82L and 82R moves along the time axis such that the operated position is in the middle of the range. At this time, the distance between the range specifying portions 82L and 82R after the move is maintained the same as the distance before the move. In FIG. 5B, since a tap operation is performed at a portion near 12:00 (FIG. 5B-a), each of the range specifying portions 82L and 82R moves along the time axis such that the portion near 12:00 is in the middle of the range, with the distance between the range specifying portions 82L and 82R maintained (FIG. 5B-b).

Hence, when the type of operation is a tap operation, the range adjustment unit 14 moves each of the range specifying portions 82L and 82R along the time axis and adjusts the range of the display range 820 such that the starting position of the operation is in the middle of the range specifying portions 82L and 82R. In FIG. 5B, the display range 820 in which a portion near 15:00 has been in the middle of the range (FIG. 5B-a) is adjusted to a range in which a portion near 12:00 is in the middle of the range according to the operation of the user (FIG. 5B-b).

Returning back to FIG. 1, the display control unit 15 generates the time series graphs 81 and 83 having an initial range set by the reference setting unit 11, that is, the display control unit 15 generates the time series graphs 81 and 83 by reading from the traffic intensity management database 71 data for forming the time series graphs 81 and 83 having an initial range, and then displays the graphs on the display unit 8. For example, when a period of one day is set as an initial range, the display control unit 15 displays the time series graphs 81 and 83 shown in FIG. 3 on the display unit 8.

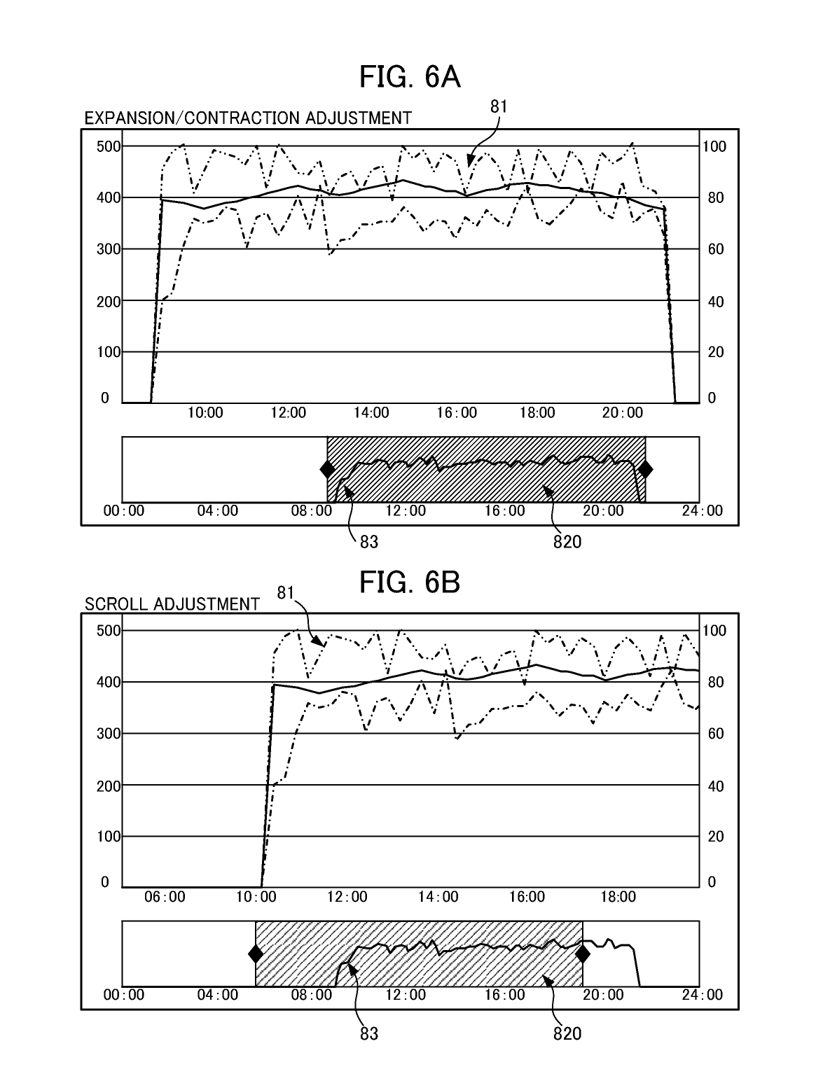

In addition, when the range adjustment unit 14 adjusts the range of the time series graph 81, that is, when the range adjustment unit 14 adjusts the adjustment range 820, the display control unit 15 adjusts the time series graph 81 (i.e., expansion/contraction or scroll) and then displays the graph on the display unit 8. For example, when the display range 820 that has showed the range of 00:00 to 24:00 is adjusted to show a range of about 08:00 to about 21:00 as shown in FIG. 4B, the display control unit 15 expands the time series graph 81 shown in FIG. 3 and displays the time series graph 81 shown in FIG. 6A on the display unit 8.

It should be noted that the display control unit 15 may newly create a post-expansion/contraction or post-scroll time series graph 81 based on the data stored in the traffic intensity management database 71, and the post-expansion/contraction or post-scroll time series graph 81 may be displayed on the display unit 8 by expanding/contracting or scrolling the already generated time series graph 81 having the initial range. That is, the expansion/contraction or scroll of the time series graph 81 can be achieved by any method. For example, the display control unit 15 may read from the traffic intensity management database 71 the data for a range that is adjusted by the range adjustment unit 14 and newly generate the time series graph 81 in which such data is plotted, and the time series graph 81 having the initial range may be held as the image data and re-display the image data by expanding/contracting or scrolling the graph.

As described above, in the information processing apparatus 100 according to the present embodiment, it is possible to perform expansion/contraction and scroll of the time series graph 81 displayed in the main display portion 8A using the range specifying portions 82L and 82R displayed in the auxiliary display portion 8B. From the view of the user, it is possible to operate freely the time series graph 81 and improve convenience by using one operating portion (user interface).

In addition, the range specifying portions 82L and 82R set the range of the time series graph 81 displayed in the main display portion 8A by moving along the time axis the time series graph 83 which is formed by substantially contracting the time series graph 81 of the main display portion 8A. From the view of the user, since it is possible to have knowledge of the post-adjustment time series graph 81 from the characteristics of the substantially contracted time series graph 83 in advance and it is not necessary to repeat unnecessary adjustment, it is possible to improve convenience furthermore.

Specifically, when the user desires to display the time series graph 81 having a range from the standup to the end in a situation where the time series graph 81 having the initial range shown in FIG. 3 is displayed, the user can easily display a time series graph 81 having the desired range as shown in FIG. 6A by moving the range specifying portions 82L and 82R while checking the time series graph 83 displayed in the auxiliary display portion 8B.

Especially, the time series graph 83 displayed in the auxiliary display portion 8B is effective upon repeating the adjustment of the time series graph 81 over again. That is, as shown in FIG. 6A, although the time axes of the time series graphs 81 and 83 are different from each other after once the time series graph 81 is adjusted, it is possible to easily adjust the display range of the time series graph 81 even if the time series graph 81 has a different time axis by checking the time series graph 83 in the auxiliary display portion 8B. For example, even in a case where the time series graph 81 shown in FIG. 6A is scrolled to display a time series graph 81 shown in FIG. 6B, it is possible to scroll the time series graph 81 to a desired position by moving the range specifying portions 82L and 82R while checking the time series graph 83 in the display range 820.

### [Processing in the Information Processing Apparatus 100]

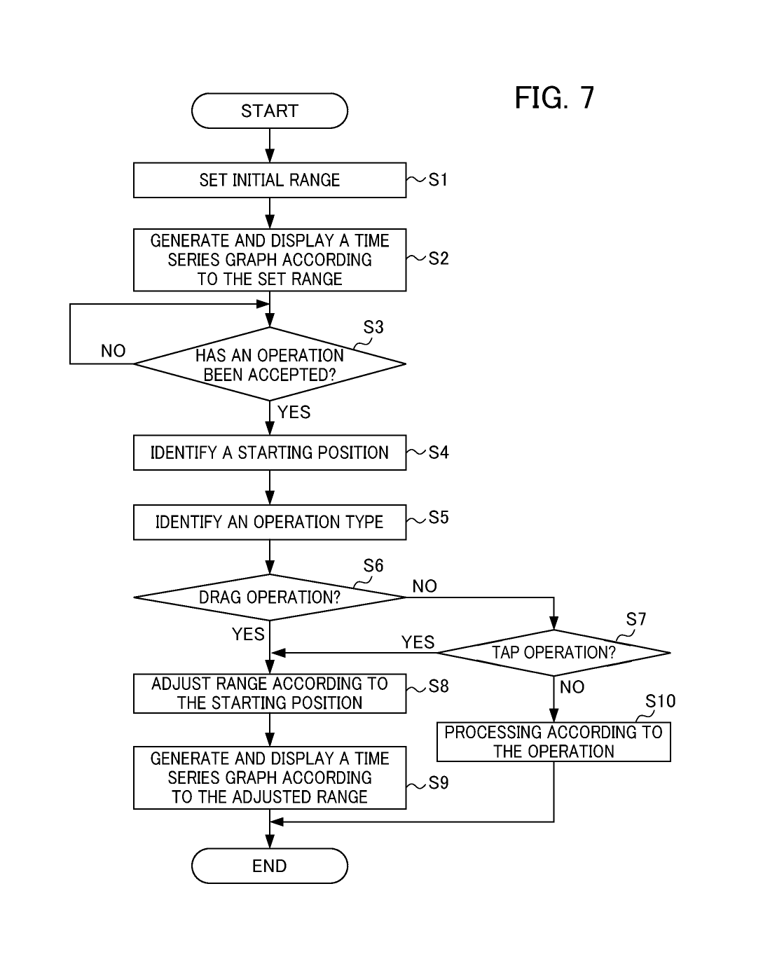

The configuration of the information processing apparatus 100 of the present invention has been described above. Next, the flow of the processing executed by the information processing apparatus 100 will be described with reference to FIG. 7.

First, the reference setting unit 11 sets the initial range of the time series graphs 81 and 83 that are to be displayed in the main display portion 8A and the auxiliary display portion 8B (Step S1). It should be noted that the initial range to be set may be accepted from the user and may be determined in advance. Next, the display control unit 15 generates the time series graphs 81 and 83 according to the initial range based on the data read from the traffic intensity management database 71 for displaying on the display unit 8 (Step S2).

Next, the operation accepting unit 61 waits until accepting an operation of the user (Step S3), and when the operation of the user is accepted, processing in Step S4 is performed. In Step S4, the starting position identification unit 12 identifies the starting position of the operation of the user. Next, the operation identification unit 13 identifies the type of the operation of the user (Step S5).

Next, the range adjustment unit 14 determines whether or not the identified type of operation is a drag operation (Step S6), and if the type is not a drag operation, the range adjustment unit 14 determines whether or not the type is a tap operation (Step S7).

At this time, if the operation is a drag operation or a tap operation, the range adjustment unit 14 adjusts the range of the time series graph 81 displayed in the main display portion 8A based on the starting position and the type of operation (Step S8). That is, the range adjustment unit 14 moves the range specifying portions 82L and 82R along the time axis of the time series graph 83 based on the starting position and the type of operation and adjusts the range of the time series graph 81 such that the range is the adjusted range (display range 820) as a result of the move. Next, the display control unit 15 generates the time series graph 81 corresponding to the adjusted range for displaying in the main display portion 8A (Step S9), and ends the processing.

Meanwhile, if the operation is neither of a drag operation nor a tap operation, the CPU 1 executes processing according to the operation (Step S10) and ends the processing.

The information processing apparatus 100 according to the present embodiment has been described above. According to such an information processing apparatus 100, it is possible to perform expansion/contraction and scroll of the time series graph 81 and improve convenience by using only one operating portion, which is constituted by the range specifying portions 82L and 82R which move along the time axis. In addition, since the time series graph 83, which is a substantially contracted graph of the time series graph 81 which is to be adjusted, is displayed on the time axis along which the range specifying portions 82L and 82R move, it is possible to have knowledge in advance of the post-adjustment time series graph 81 upon adjusting the time series graph 81 and eliminate the need to repeat unnecessary adjustments, and thus it is possible to improve convenience furthermore.

Although the embodiment of the present invention has been described in the above, the present invention is not limited to the embodiment described above. In addition, the effects described for the present embodiment are merely a result of listing the most suitable effects that arise from the present invention, and the effect according to the present invention is not limited to the effects described for the present embodiment.

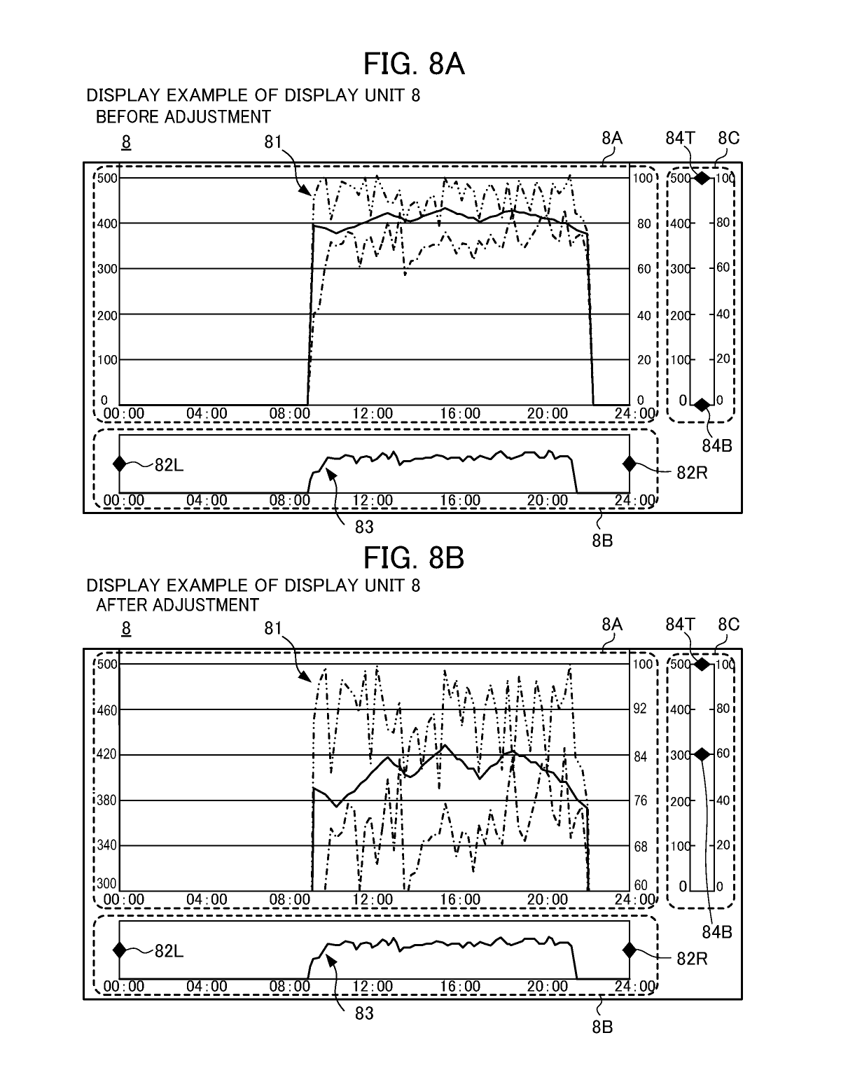

For example, although the time series graph 81 can be adjusted only along the time axis in the above embodiment, the present invention is not limited to this, and the time series graph 81 may be adjustable also along an axis perpendicular to the time axis. That is, as shown in FIGS. 8A,8B, the time series graph 81 may be adjusted along an axis perpendicular to the time axis by having a second auxiliary display portion 8C along the axis perpendicular to the time axis of the time series graph 81 and accepting an operation of the user using the second range specifying portion 84T or 84B which moves along the axis of the second auxiliary display portion 8C. The description for specific behavior in a case that uses the second auxiliary display portion 8C is omitted for details as it is fundamentally the same as the behavior in the case that uses the auxiliary display portion 8B. However, in this case, the display control unit 15 displays in the main display portion 8A the time series graph 81 having the range that the second range specifying portions 84T and 84B specify. That is, regarding the display control unit 15, if the range that the second range specifying portions 84T and 84B specify becomes small, the time series graph 81 expands in an axis perpendicular to the time axis, and if the range that the second range specifying portions 84T and 84B specify becomes large, the time series graph 81 is contracted in the axis perpendicular to the time axis. In addition, if the second range specifying portions 84T and 84B move while maintaining the range that the second range specifying portions 84T and 84B specify, the display control unit 15 scroll the time series graph 81 along the axis perpendicular to the time axis.

For example, the user who desires expansion of the time series graph 81 having a range of traffic intensity 0 to 500 (response rate: 0% to 100%) shown in FIG. 8A can display the time series graph 81 expanded in a direction of the axis perpendicular to the time axis as shown in FIG. 8B by moving the second range specifying portions 84T and 84B. That is, in FIG. 8B, the time series graph 81 that is expanded to the range of traffic intensity 300 to 500 (response rate: 60% to 100%) is displayed on the display unit 8.

In addition, the above-described information processing apparatus 100 may be achieved by one terminal unit, and may also be achieved by a plurality of terminal units. That is, in a service that provides a time series graph using the Internet or the like, the time series graph can be adjusted by working together with a server that provides a service instead of enabling adjustment of the time series graph in one terminal unit. For example, the traffic intensity management database 71 provided in the storage unit 7 may be provided in the server and a time series graph specified by the server may be displayed in the terminal unit (user terminal).

In addition, the information processing apparatus 100 may be any terminal unit (computer) and each of the above-described functions is realized by software. When the function is realized by software, a program including such software is installed in the information processing apparatus 100. In addition, these programs may be recorded in a removable media, such as CD-ROM, for distribution and may be distributed by being downloaded to the information processing apparatus 100 via a network.

What is claimed is:

1. An information processing apparatus, comprising:
a reference setting unit which sets an initial range of a time series graph;
a display control unit which displays on a display unit the time series graph having the set initial range and an operating portion having a time axis that corresponds to a time axis of the time series graph by associating the time axes with each other;
an operation accepting unit which accepts an operation of a user using a range specifying portion which is arranged at both ends of the operating portion in the time axis direction and moves along the time axis; and
a range adjustment unit which adjusts a range of the time series graph by moving, when a starting position of an operation that the operation accepting unit accepted is either of the range specifying portions, the operated range specifying portion along a time axis of the operating portion, and by moving, when the starting position is in between the range specifying portions, both of the range specifying portions along the time axis of the operating portion with a distance between the range specifying portions being maintained; wherein
the display control unit displays on the display unit the time series graph having a range adjusted by the range adjustment unit.

2. The information processing apparatus according to claim 1, wherein
the operating portion is a time series graph which is a substantially contracted graph of the time series graph.

3. The information processing apparatus according to claim 1, wherein
on a condition that the operation accepting unit accepts a selection operation performed onto an arbitrary position in the time axis direction of the operating portion, the range adjustment unit adjusts the range of the time series graph to a range in which the arbitrary position is in a middle of the range.

4. The information processing apparatus according to claim 1, further comprising
a second operation accepting unit which accepts an operation from the user using a second range specifying portion which is provided along an axis perpendicular to the time axis of the time series graph and moves along an axis corresponding to the axis, wherein
the display control unit displays on the display unit a time series graph having a range determined by the second range specifying portion.

5. A method for a computer to adjust a display range of a time series graph, comprising:
a step of setting an initial range of the time series graph;
a step of displaying on a display unit the time series graph having the set initial range and an operating portion having a time axis that corresponds to a time axis of the time series graph by associating the time axes with each other;
a step of accepting an operation of a user using a range specifying portion which is arranged at both ends of the operating portion in the time axis direction and moves along the time axis;
a step of adjusting a range of the time series graph by moving, when a starting position of an accepted operation is on either of the range specifying portions, the operated range specifying portion along a time axis of the operating portion, and by moving, when the starting position is in between the range specifying portions, both of the range specifying portions along the time axis of the operating portion with a distance between the range specifying portions being maintained; and
a step of displaying on the display unit the time series graph having an adjusted range.

6. A program for causing a computer to adjust a display range of a time series graph, the program causing the computer to execute:
a step of setting an initial range of the time series graph;
a step of displaying on a display unit the time series graph having the set initial range and an operating portion having a time axis that corresponds to a time axis of the time series graph by associating the time axes with each other;
a step of accepting an operation of a user using a range specifying portion which is arranged at both ends of the operating portion in the time axis direction and moves along the time axis;
a step of adjusting a range of the time series graph by moving, when a starting position of an accepted operation is on either of the range specifying portions, the operated range specifying portion along a time axis of the operating portion, and by moving, when the starting position is in between the range specifying portions, both of the range specifying portions along the time axis of the operating portion with a distance between the range specifying portions being maintained; and
a step of displaying on the display unit the time series graph having an adjusted range.
